(19) United States
(12) Patent Application Publication
(10) Pub. No.: US 2024/0287233 A1
(43) Pub. Date: Aug. 29, 2024

(54) FREE-RADICALLY POLYMERIZABLE COPOLYMER, FREE-RADICALLY POLYMERIZABLE COMPOSITION CONTAINING THE SAME, AND POLYMERIZED REACTION PRODUCT THEREFROM

(71) Applicant: 3M INNOVATIVE PROPERTIES COMPANY, St. Paul, MN (US)

(72) Inventors: Claire Hartmann-Thompson, Lake Elmo, MN (US); Vasav Sahni, St. Paul, MN (US)

(21) Appl. No.: 18/569,971

(22) PCT Filed: Jun. 10, 2022
(86) PCT No.: PCT/IB2022/055424

§ 371 Date: Dec. 13, 2023

Related U.S. Application Data
(60) Provisional application No. 63/211,299, filed on Jun. 16, 2021.

(51) Int. Cl. C08F 255/10; C08F 2/50

(52) U.S. Cl. CPC C08F 255/10; C08F 2/50

(57) ABSTRACT

A free-radically polymerizable copolymer comprising divalent monomeric units: a); b); and optionally c). Each R¹ independently represents an alkyl group having from 1 to 8 carbon atoms. R² represents H or a methyl group. Z represents an alkylene group having 2 to 12 carbon atoms. X⁻ represents a non-interfering anion. Free-radically polymerizable compositions containing the same are also disclosed as well as the corresponding polymerized compositions.

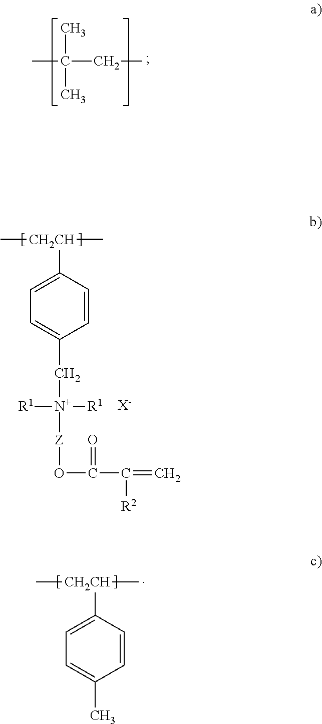

### TECHNICAL FIELD

The present disclosure broadly relates to free-radically polymerizable copolymers having isobutylene and (meth)acryloxy-functionalized styrene monomeric units and curable compositions containing them.

### BACKGROUND

Polyisobutylene is one of the best performing commodity polymers for fifth generation technology standard (5G) telecommunications devices in terms of its low dielectric constant (Dk 2.2 at 2.5 GHz), low dissipation factor (Df 0.0005 at 2.5 GHz), barrier properties, and moisture and chemical resistance, but it is a gum. To be useful in many 5G applications (e.g., adhesive and film applications) it must be crosslinked to some degree.

### SUMMARY

Advantageously, the present disclosure provides free-radically polymerizable isobutylene copolymers functionalized with pendant (meth)acrylate groups, compositions containing them, and crosslinked reaction products thereof. After free-radical polymerization they form crosslinked polymer networks. The unpolymerized copolymers and polymerized compositions are generally well-suited for use in 5G applications.

In a first aspect, the present disclosure provides a free-radically polymerizable copolymer comprising divalent monomeric units:

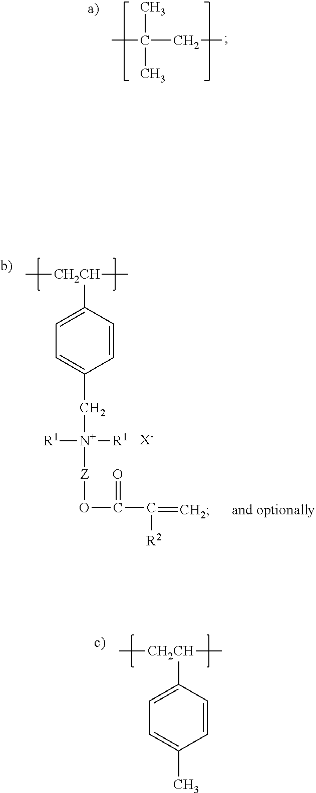

wherein:
   each R¹ independently represents an alkyl group having from 1 to 8 carbon atoms,
   R² represents H or a methyl group,
   Z represents an alkylene group having 2 to 12 carbon atoms; and
   X⁻ represents a non-interfering anion.

In another aspect, the present disclosure provides a free-radically polymerizable composition comprising components:
i) at least one free-radically polymerizable copolymer according to the present disclosure;
ii) at least one free-radically polymerizable monomer; and
iii) optional free-radical initiator.

In yet another aspect, the present disclosure provides a polymerized reaction product of a free-radically polymerizable composition according to the present disclosure.

As used herein, the term “(meth)acryl” refers to acryl and/or methacryl; and the term “non-interfering anion” refers to any anion (organic or inorganic) that does not adversely affect free-radical polymerization.

Features and advantages of the present disclosure will be further understood upon consideration of the detailed description as well as the appended claims.

### DETAILED DESCRIPTION

Useful free-radically polymerizable copolymers comprise the divalent monomeric units:

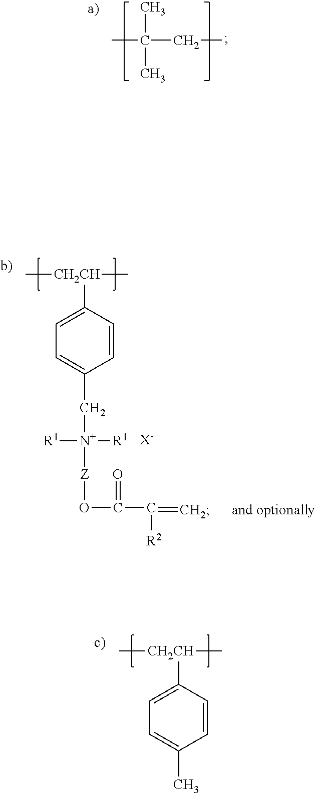

Each R¹ independently represents an alkyl group having from 1 to 8 carbon atoms, preferably 1 to 4 carbon atoms, and more preferably 1 or 2 carbon atoms. Examples include methyl, ethyl, propyl, butyl, pentyl, hexyl, heptyl and octyl.

R² represents H or a methyl group.

Z represents an alkylene group having 2 to 12 carbon atoms, preferably 2 to 8 carbona toms, more preferably 2 to 6 carbon atoms, and more preferably 2 to 4 carbon atoms.

X⁻ represents a non-interfering anion as defined hereinbefore. Examples of suitable non-interfering anions may include (depending on the other components) fluoride, chloride, bromide, complex metal halides (e.g., hexafluorophosphate, hexafluoroantimonate, pentafluorohydroxyantimonate, tetrachlorostannate, hydroxide, sulfonates (e.g., trifluoromethanesulfonate, methanesulfonate, p-toluenesulfonate), tetrafluoroborate, nitrate, sulfate, carbonate, bicarbonate, phosphate or phosphonate, perchlorate; nitrate; carbonate; sulfate; and bicarbonate.

The foregoing polymers can be synthesized, for example, from a corresponding copolymer of p-methylstyrene and isobutylene through the steps of, for example, free-radical bromination of some or all of the benzylic methyl groups and subsequent nucleophilic reaction with a tertiary aminoalkyl (meth)acrylate such as one represented by the formula:

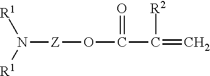

wherein R¹, R², and Z are as previously defined. Generally, sufficient functionalization of the brominated copolymer (or other suitable precursor) occurs that the resultant free-radically polymerizable copolymer comprises at least 2, at least 3, or even at least 4-(meth)acryloxy groups, although some monofunctional copolymer may be useful in some cases.

Brominated copolymers of isoprene and p-methylstyrene, where the bromine atoms are bonded to benzylic carbon atoms, are commercially available under the trade designation EXXPRO from ExxonMobil, Houston, Texas (e.g., in grades EXXPRO 3563, EXXPRO 3035, EXXPRO 3745, and EXXPRO 3433).

Examples of suitable such tertiary amines include: N,N-dimethylaminoethyl (meth)acrylate, N,N-diethylaminoethyl (meth)acrylate, N-ethyl-N-methylaminoethyl (meth)acrylate, N,N-dimethylamino-propyl (meth)acrylate, N,N-diethylaminopropyl (meth)acrylate, N,N-dimethylaminobutyl (meth)acrylate, N,N-diethylaminobutyl (meth)acrylate, N,N-dimethylaminohexyl (meth)acrylate, N,N-diethylaminohexyl (meth)acrylate, N,N-dimethylaminooctyl (meth)acrylate, N,N-diethylaminooctyl (meth)acrylate, N,N-dipropylaminoethyl (meth)acrylate, N,N-dibutylaminoethyl (meth)acrylate, N,N-dipentylaminoethyl (meth)acrylate, N,N-dihexylaminoethyl (meth)acrylate, and N,N-dioctylaminoethyl (meth)acrylate. These tertiary amines can be obtained from commercial suppliers and/or synthesized by known methods.

While the above procedure yields bromide salts, other salts can be readily prepared, for example, by well-known ion exchange methods (e.g., using an anion-exchange column).

The ratio of monomer units a), b), and optional c) can be any ratio. Typically, it is desirable to have a large majority of monomer unit a) since it has the most desirable properties for 5G communications applications. In some embodiments, the mole ratio of component a) to components b) and optional c) combined is at least 80:20, at least 85:15, at least 90:10, at least 95:5, at least 97:3, at least 98:2 or even at least 99:1.

The ratio of monomer unit b) to monomer unit c), if it is present at all, may be in any molar ratio. Examples include 99:1 to 1:99, 99:1 to 95:5, 99:1 to 90:10, and 99:1 to 80:20, although other ratios may also be used.

At least one free-radically polymerizable copolymer according to the present disclosure can be combined with at least one free-radically polymerizable monomer, and optional free-radical photoinitiator.

Exemplary suitable free-radically polymerizable monomers include mono- and polyfunctional (i.e., having at least two (meth)acryl groups) (meth)acrylic monomers. Any ratio of the free-radically polymerizable copolymer and free-radically polymerizable monomers may be used. In some embodiments, the weight ratio of free-radically polymerizable copolymer to free-radically polymerizable monomer(s) is 5:95 to 50:50, preferably 10:90 to 25:75

Examples of free-radically polymerizable (meth)acrylic monomers include, for example, mono-, di- or poly(meth)acrylics (e.g., acrylates and methacrylates) such as methyl (meth)acrylate, ethyl acrylate, isopropyl methacrylate, n-hexyl acrylate, 2-ethylhexyl acrylate, isobornyl acrylate, stearyl acrylate, allyl acrylate, glycerol triacrylate, ethylene glycol diacrylate, diethylene glycol diacrylate, triethylene glycol dimethacrylate, tricyclodecanedimethanol dimethacrylate, 1,10-decanediol dimethacrylate, 1,3-propanediol di(meth)acrylate, trimethylolpropane triacrylate, 1,2,4-butanetriol trimethacrylate, 1,4-cyclohexanediol diacrylate, pentaerythritol tetra(meth)acrylate, sorbitol hexaacrylate, tetrahydrofurfuryl (meth)acrylate, bis[1-(2-acryloxy)]-p-ethoxyphenyldimethylmethane, bis[1-(3-acryloxy-2-hydroxy)]-p-propoxyphenyldimethylmethane, ethoxylated bisphenol A di(meth)acrylate, and trishydroxyethyl-isocyanurate trimethacrylate; (meth)acrylamides (i.e., acrylamides and methacrylamides) such as (meth)acrylamide, methylene bis-(meth)acrylamide, and diacetone (meth)acrylamide; urethane (meth)acrylates; the bis-(meth)acrylates of polyethylene glycols (typically of molecular weight 200-500); copolymerizable mixtures of acrylated monomers such as those in U.S. Pat. No. 4,652,274 (Boettcher et al.); acrylated oligomers such as those of U.S. Pat. No. 4,642,126 (Zador et al.); and vinyl compounds such as styrene, diallyl phthalate, divinyl succinate, divinyl adipate and divinyl phthalate. Other suitable additional free-radically polymerizable monomers include siloxane-functional (meth)acrylates as disclosed, for example, in PCT Pat. Publ. Nos. WO 00/38619 (Guggenberger et al.), WO 01/92271 (Weinmann et al.), WO 01/07444 (Guggenberger et al.), WO 00/42092 (Guggenberger et al.), and fluoropolymer-functional (meth)acrylates as disclosed, for example, in U.S. Pat. No. 5,076,844 (Fock et al.), U.S. Pat. No. 4,356,296 (Griffith et al.), and Eur. Pat. Appl. Nos. 0 373 384 (Wagenknecht et al.), 0 201 031 (Reiners et al.), and 0 201 778 (Reiners et al.).

Still further examples of additional free-radically polymerizable monomers include such materials as hydroxyalkyl (meth)acrylates, such as 2-hydroxyethyl (meth)acrylate and 2-hydroxypropyl (meth)acrylate; glycerol mono- or di-(meth)acrylate; trimethylolpropane mono- or di-(meth)acrylate; pentaerythritol mono-, di-, and tri-(meth)acrylate; sorbitol mono-, di-, tri-, tetra-, or penta-(meth)acrylate; and 2,2-bis[4-(2-hydroxy-3-methacryloxypropoxy)phenyl]propane.

One exemplary useful free-radically polymerizable compound is available as CN309 acrylate esters based off of an aliphatic hydrophobic backbone from Sartomer Co., Exton, Pennsylvania.

Exemplary suitable free-radically polymerizable monomers also include alkenes having one or more carbon-carbon double bonds and having 1 to 18 carbon atoms (e.g., ethylene, propylene, butene, butadiene, isoprene, hexene, cyclohexene, octene, decene, hexadecene, or octadecene). While other free-radically polymerizable monomers may be included.

In some embodiments, suitable free-radically polymerizable monomers are free of N, P, and/or S atoms. In some embodiments, suitable free-radically polymerizable monomers are free of N, O, P, and/or S atoms.

As used herein, the term “free-radical photoinitiator” refers to any compound or combination of compounds that can cause free-radical polymerization or copolymerization when exposed to actinic radiation (e.g., ultraviolet and/or visible light). Choice of free-radical initiator, amounts, and polymerization conditions is within the capability of those having ordinary skill in the art.

The free-radical photoinitiator is typically included in at least an effective amount. By the term “effective amount” is meant an amount that is at least sufficient amount to cause free-radical polymerization of the free-radically polymerizable composition under polymerization conditions. Typically, the total amount of free-radical initiator is used in amounts ranging from 0.0001 to 20 percent by weight (preferably 0.001 to 5 percent by weight), based on the total weight of the free-radically polymerizable composition, although this is not a requirement.

Examples of free-radical photoinitiators include: 2-benzyl-2-(dimethylamino)-4′-morpholino-butyrophenone; 1-hydroxycyclohexyl-phenyl ketone; 2-methyl-1-[4-(methylthio)phenyl]-2-morpholino-propan-1-one; 4-methylbenzophenone; 4-phenylbenzophenone; 2-hydroxy-2-methyl-1-phenylpropanone; 1-[4-(2-hydroxyethoxyl)-phenyl]-2-hydroxy-2-methylpropanone; 2,2-dimethoxy-2-phenylacetophenone; 4-(4-methylphenylthio)benzophenone; benzophenone; 2,4-diethylthioxanthone; 4,4′-bis(diethylamino)-benzophenone; 2-isopropylthioxanthone; acylphosphine oxide derivatives, acylphosphinate derivatives, and acylphosphine derivatives (e.g., phenylbis(2,4,6-trimethylbenzoyl)phosphine oxide (available as OMNIRAD 819 from IGM Resins, St. Charles, Illinois), phenylbis(2,4,6-trimethylbenzoyl)phosphine (e.g., as available as OMNIRAD 2100 from IGM Resins), bis(2,4,6-trimethylbenzoyl)phenylphosphine oxide, 2,4,6-trimethylbenzoyldiphenylphosphine oxide (e.g., as available as OMNIRAD 8953X from IGM Resins), isopropoxyphenyl-2,4,6-trimethylbenzoylphosphine oxide, dimethyl pivaloylphosphonate), ethyl (2,4,6-trimethylbenzoyl)phenyl phosphinate (e.g., as available as OMNIRAD TPO-L from IGM Resins); bis(cyclopentadienyl) bis[2,6-difluoro-3-(1-pyrryl)phenyl]titanium (e.g., as available as OMNIRAD 784 from IGM Resins); and combinations thereof.

Suitable sources of actinic radiation include, for example, lasers, arc lamps (e.g., medium pressure mercury arc lamps), LED lamps, xenon flash lamps, microwave-driven lamps (e.g., equipped with H-type bulb or D-type bulb). Selection of appropriate exposure conditions will be within the capability of those skilled in the art.

The amount of the free-radical photoinitiator is typically in a range of 0.01 to 5 weight percent based on the total weight of the membrane precursor composition. The amount can be at least 0.01 weight percent, at least 0.05 weight percent, at least 0.1 weight percent, at least 0.5 weight percent, at least 1 weight percent and up to 5 weight percent, up to 4 weight percent, up to 3 weight percent, up to 2 weight percent, or up to 1 weight percent; however, higher amounts may also be used.

The free-radically polymerizable composition can be polymerized to provide a corresponding polymerized reaction product, which may be useful, for example, as a gap filler, adhesive, and/or sealant, especially in 5G-enabled telecommunication devices (e.g., cell phones), laptop computers, and tablet computers.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight.

Table 1, below, reports designations, descriptions and Sources of materials used in the examples.

TABLE 1

| DESIGNATION | DESCRIPTION | SOURCE |
|---|---|---|
| EXXPRO 3745 | EXXPRO 3745 Specialty | ExxonMobil Chemical, Houston, Texas |
| | Elastomer, brominated copolymer | |
| | of isobutylene and p-methylstyrene | |
| | having no backbone unsaturation, | |
| | 2.3 wt. % bromine | |
| DEAEM | 2-Diethylaminoethyl methacrylate, | TCI America, Portland, Oregon |
| | Product No. M0562 | |
| CN-309 | CN309 acrylate esters based off of | Sartomer, Exton, Pennsylvania |
| | an aliphatic hydrophobic backbone | |
| DCP | NK ESTER A-DCP | Kowa, Shin Nakamura, Tokyo Japan |
| | tricyclodecanedimethanol | |
| | dimethacrylate | |
| DDMA | 1,10-decanediol dimethacrylate, | Esstech, Inc., Essington, Pennsylvania |
| | Cat. No. X-733-7446 | |
| TPO-L | OMNIRAD TPO-L photoinitiator, | IGM Resins, St. Charles, Illinois |
| | 2,4,6-Trimethylbenzoylphenyl- | |
| | phosphinic acid ethyl ester | |

### Test Methods

### Nuclear Magnetic Resonance (NMR) Spectroscopy

NMR spectroscopy was conducted using a Bruker AVANCE IM 500 MHz NMR spectrometer equipped with a CPBBO gradient cryoprobe, a Bruker B-ACS 60 autosampler, and Bruker Topspin 3.04 software, Proton NMR spectra were recorded with a 15° ¹H excitation pulse and acquisition time of 4 seconds. Two-dimensional (2D)¹H-¹³C NMR spectra were also collected, and were recorded in the HSQC (heteronuclear single quantum coherence) adiabatic material sweep width mode. Spectra were analyzed using Advanced Chemistry Development software (Toronto, Canada).

### Dielectric Measurements

Samples were prepared by pouring 10 mL of formulation solution (25 wt. % in toluene) into a Teflon lined glass petri dish and drying at room temperature for 24 hrs. The resulting discs were peeled away from the Teflon and characterized for dielectric constant and dissipation factor at 10.1 GHz.

### Split Post Dielectric Resonator Measurements for Solids at 10.1 GHz

Split-post dielectric resonator measurements were performed in accordance with the standard IEC 61189-2-721:2015 “Test Methods For Electrical Materials, Printed Boards And Other Interconnection Structures And Assemblies—Part 2-721: Test Methods For Materials For Interconnection Structures—Measurement Of Relative Permittivity And Loss Tangent For Copper Clad Laminate At Microwave Frequency Using A Split Post Dielectric Resonator” at a frequency of 10.1 GHz. Each thin material or film was inserted between two fixed dielectric resonators. The effect of the specimen upon the resonance frequency and quality factor of the posts enables the direct computation of complex permittivity (dielectric constant and dielectric loss). The 10.1 GHz resonator operates with the TE_{01d} mode which has only an azimuthal electric field component so that the electric field remains continuous on the dielectric interfaces. The split post dielectric resonator measures the permittivity component in the plane of the specimen. Loop coupling (critically coupled) was used in each of these dielectric resonator measurements. This 10.1 GHz Split Post Resonator measurement system was combined with Keysight VNA (Vector Network Analyzer Model PNA 8364C 10 MHz-50 GHz). Computations were performed to determine the complex electric permittivity of each specimen at 10.1 GHz.

### Characterization by DSC

DSC samples were prepared for thermal analysis by weighing and loading the material into TA Instruments (New Castle, Delaware) aluminum DSC sample pans. The specimens were analyzed using the TA Instruments Discovery Differential Scanning Calorimeter (DSC-SN DSC1-0091) utilizing a heat-cool-heat method in standard mode (−155° C. to about 50° C. at 10° C./minute.). After data collection, the thermal transitions were analyzed using the TA Universal Analysis program. The glass transition temperatures were evaluated using the step change in the standard heat flow (HF) curves. The midpoint (half height) temperature of the second heat transition was reported.

### Preparation of Polymer 1

EXXPRO 3745 (9.22 g) was dissolved in toluene (60 mL) at 70° C. with stirring. 2-Diethyl-aminoethyl methacrylate (0.34 g) was added. The mixture was stirred at 70° C. for 3 hr, 15 mL of methoxypropanol was added, and the mixture was stirred for a further 48 hr at 70° C. The product was precipitated into acetonitrile (50 mL) and washed twice with acetonitrile (2×20 mL), dried in a solvent oven (130° C., 2 hr) and obtained as a white gum. Characterization of the product by 2D ¹H-¹³C HSQC NMR (CDCl₃) relative to the starting copolymer showed the loss of the PhCH₂Br methylene signal at 4.5 ppm (¹H)/33 ppm (13C), and the appearance of the desired PhCH₂NR₃⁺Br⁻ methylene signal at 4.0 ppm (¹H)/66 ppm (¹³C).

Dielectric constants, dissipation factors, and glass transition temperatures for EXXPRO 3745 and Polymer 1 are reported in Table 2, below.

TABLE 2

| | DIELECTRIC | | |
|---|---|---|---|
| | CONSTANT, 20° C. | TAN δ, | T_{g}, |
| EXAMPLE | at 10.1 GHz | 20° C. at 10.1 GHz | ° C. |
| EXXPRO 3745 | 2.31 | 0.0025 | −62 |
| Polymer 1 | 2.33 | 0.0053 | −62 |

Solutions (25 wt. % solids) of the formulations reported in Table 3 were prepared by heating in toluene until homogeneous. Samples were prepared by depositing 0.25 mL of formulation solution onto a glass microscope slide via pipette, and placing the slide on a hotplate (150° C., 2 mins). Samples were exposed to UV cure conditions by adding 2 wt. % TPO-L, depositing 0.25 mL of formulation onto a glass microscope slide via pipette, covering with an RF02N liner, (SKC Haas, Seoul, South Korea; 2 mil; 51 microns), and curing using a Clearstone CF1000 UV LED system (Clearstone Technologies Inc., Hopkins, Minnesota, 395 nm, 100% intensity for two minutes at a distance of 1 cm from the surface of the sample).

TABLE 3

| | EXXPRO | | Polymer | | | |
|---|---|---|---|---|---|---|
| EXAMPLE | 3745 | DEAEM | 1 | CN309 | DCP | DDMA |
| CE-1 | 100 | | | | | |
| CE-2 | | 100 | | | | |
| EX-3 | | | 100 | | | |
| EX-4 | | | 90 | 10 | | |
| EX-5 | | | 75 | 25 | | |
| EX-6 | | | 50 | 50 | | |
| EX-7 | | | 25 | 75 | | |
| EX-8 | | | 90 | | 10 | |
| EX-9 | | | 75 | | 25 | |
| EX-10 | | | 50 | | 50 | |
| EX-11 | | | 25 | | 75 | |
| EX-12 | | | 90 | | | 10 |
| EX-13 | | | 75 | | | 25 |
| EX-14 | | | 50 | | | 50 |
| EX-15 | | | 25 | | | 75 |

Response of formulations in Table 3 to cure conditions and demonstration of UV cure are reported in Table 4 (below) and 5.

TABLE 4

| | Conditions | Product | Solubility in Toluene |
|---|---|---|---|
| CE-1 | 150° C./2 min | gum | soluble |
| | No UV | | |
| | 150° C./2 min | gum | soluble |
| | UV | | |
| CE-2 | 150° C./2 min | liquid | soluble |
| | No UV | | |
| | 150° C./2 min | liquid | soluble |
| | UV | | |
| EX-3 | 150° C./2 min | gum | soluble |
| | No UV | | |
| | 150° C./2 min | gum | swollen transparent |
| | UV | | gel |

Table 5 (below) reports products of UV-cured formulations of Polymer 1 with commercial (meth)acrylates.

TABLE 5

| EXAMPLE | TRANSPARENT? | PRODUCT |
|---|---|---|
| EX-4 | yes | tacky solid |
| EX-5 | yes | tacky solid |
| EX-6 | yes | soft solid |
| EX-7 | yes | film |
| EX-8 | yes | tacky solid |
| EX-9 | yes | tacky solid |
| EX-10 | yes | soft solid |
| EX-11 | yes | film |
| EX-12 | yes | tacky solid |
| EX-13 | yes | tacky solid |
| EX-14 | yes | hard solid |
| EX-15 | yes | film |

The results reported in Table 5 show that Polymer 1 is suitable for use in formulations with common low dielectric constant (meth)acrylate monomers (CN309, DCP, and DDMA), and transparent materials (e.g., optically clear adhesives) are obtained over a range of compositions. Cured materials ranging from tacky solids to hard solid films can be obtained depending on the Polymer 1 to monomer ratio.

The preceding description, given in order to enable one of ordinary skill in the art to practice the claimed disclosure, is not to be construed as limiting the scope of the disclosure, which is defined by the claims and all equivalents thereto.

1. A free-radically polymerizable copolymer comprising divalent monomeric units: 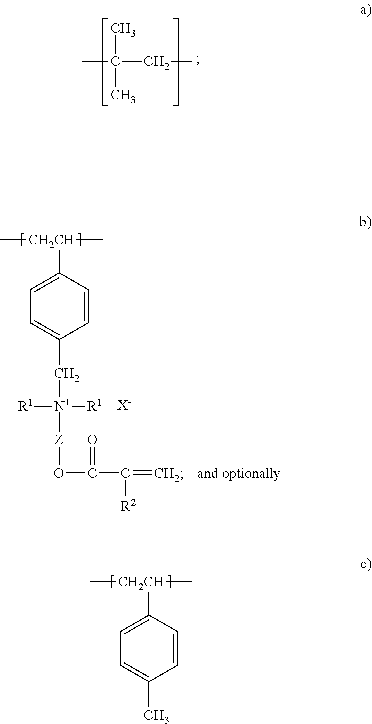
wherein:
each R¹ independently represents an alkyl group having from 1 to 8 carbon atoms,
R² represents H or a methyl group,
Z represents an alkylene group having 2 to 12 carbon atoms; and
X⁻ represents a non-interfering anion.

2. The free-radically polymerizable copolymer of claim 1, wherein monomeric unit c) is present.

3. The free-radically polymerizable copolymer of claim 1, wherein the moles of monomeric unit b) is less than or equal to 5 percent of the total moles of monomeric units a), b), and c).

4. The free-radically polymerizable copolymer of claim 1, wherein the moles of monomeric unit b) is less than or equal to 1 percent of the total moles of monomeric units a), b), and c).

5. The free-radically polymerizable copolymer of claim 1, wherein each R¹ is independently a methyl or ethyl group.

6. The free-radically polymerizable copolymer of claim 1, wherein Z represents an alkylene group having 2 to 8 carbon atoms.

7. The free-radically polymerizable copolymer of claim 1, wherein Z represents an alkylene group having 2 to 4 carbon atoms.

8. The free-radically polymerizable copolymer of claim 1, wherein Z represents an ethylene group.

9. The free-radically polymerizable copolymer of claim 1, wherein X⁻ represents chloride, bromide, hexafluorophosphate, hexafluoroantimonate, pentafluorohydroxyantimonate, or hydroxide.

10. A free-radically polymerizable composition comprising components:
i) at least one free-radically polymerizable copolymer according to claim 1;
ii) at least one free-radically polymerizable monomer; and
iii) optional free-radical initiator.

11. The free-radically polymerizable composition of claim 10, wherein component ii) comprises a free-radically polymerizable monomer comprising at least two (methacryl) groups.

12. The free-radically polymerizable composition of claim 10, wherein component iii) is present and comprises a photoinitiator.

13. A polymerized reaction product of the free-radically polymerizable composition of claim 10.

14. A polymerized reaction product of the free-radically polymerizable composition of claim 11.

15. A polymerized reaction product of the free-radically polymerizable composition of claim 12.
